(19) United States
(12) Patent Application Publication
(10) Pub. No.: US 2025/0266482 A1
(43) Pub. Date: Aug. 21, 2025

(54) APPARATUS AND METHOD FOR GUIDING ELECTRODE PLATE

(71) Applicant: Samsung SDI Co., Ltd., Yongin-si (KR)

(72) Inventors: Jae Kyung CHO, Yongin-si (KR); Seong Bong CHO, Yongin-si (KR); Jeongho KANG, Yongin-si (KR)

(21) Appl. No.: 18/805,255

(22) Filed: Aug. 14, 2024

(30) Foreign Application Priority Data
Feb. 16, 2024 (KR) 10-2024-0022551

(51) Int. Cl. H01M 10/04

(52) U.S. Cl. CPC H01M 10/0404

(57) ABSTRACT

An apparatus for guiding an electrode plate, includes: a flat plate-shaped stage having a plurality of through-holes, and including an upper surface to receive a target electrode plate thereon; a plurality of transfer guides in the plurality of through-holes, and to inject an injection gas to change a transfer direction of the target electrode plate and discharge the target electrode plate from the stage; and a controller to control the plurality of transfer guides to change an injection direction of the injection gas according to the transfer direction of the target electrode plate.

### CROSS-REFERENCE TO RELATED APPLICATION

The present application claims priority to and the benefit of Korean Patent Application No. 10-2024-0022551, filed on Feb. 16, 2024, in the Korean Intellectual Property Office, the entire disclosure of which is incorporated by reference herein.

### BACKGROUND

### 1. Field

Aspects of embodiments of the present disclosure relate to an apparatus for guiding an electrode plate, and a method for guiding the electrode plate using the apparatus. More particularly, aspects of embodiments of the present disclosure relate to an apparatus for guiding an electrode plate for a secondary battery in a desired direction, and a method for guiding the electrode plate using the apparatus.

### 2. Description of the Related Art

In general, electrodes for secondary batteries may be obtained by coating a mixture of active materials, conductive additives, and binders onto a substrate to form an electrode sheet through a coating process. Thereafter, a rolling process may be performed to increase the mixture density (electrode density) in the electrode sheet, and then the electrode sheet may be cut to meet the desired specifications of the battery.

The cut positive electrode plates or negative electrode plates (hereinafter referred to as “electrode plates”) are supplied to an electrode assembly process via a conveyor belt or a vacuum belt. In other words, the electrode plates produced by the cutting process may be transferred to a next process via a feeding line such as a belt.

The above information disclosed in this Background section is for enhancement of understanding of the background of the present disclosure, and therefore, it may contain information that does not constitute related (or prior) art.

### SUMMARY

Comparative conveyor belts for transferring the electrode plates may only move and transfer the electrode plates in a direction in which the belt travels, which may make it difficult to change the transfer direction (e.g., the movement direction) of the electrode plates being transferred.

As such, processes have been proposed that utilize a transfer structure, such as a robotic arm or an air blower, to change the transfer direction (e.g., the movement direction) of the electrode plate. However, introducing a separate transfer structure, such as a robot arm, may be difficult due to an excessive installation area and high costs. Further, it may be difficult to accurately control the transfer direction of the electrode plate to a desired direction using an air blower. Therefore, an improved apparatus for guiding the electrode plates for secondary batteries that may more easily control the transfer direction of the electrode plate while reducing the installation area may be desired.

One or more embodiments of the present disclosure may be directed to an electrode plate guiding apparatus for improving a control accuracy in a transfer direction of an electrode plate by using a decreased (e.g., smaller) installation area.

One or more embodiments of the present disclosure may be directed to a method of guiding an electrode plate in which a transfer direction of the electrode plate is easily changed by the electrode plate guiding apparatus.

These and other aspects and features of the present disclosure will be described in or will be apparent from the following description of embodiments of the present disclosure.

According to one or more embodiments of the present disclosure, an apparatus for guiding an electrode plate, includes: a flat plate-shaped stage having a plurality of through-holes, and including an upper surface configured to receive a target electrode plate thereon; a plurality of transfer guides in the plurality of through-holes, and configured to inject an injection gas to change a transfer direction of the target electrode plate and discharge the target electrode plate from the stage; and a controller configured to control the plurality of transfer guides to change an injection direction of the injection gas according to the transfer direction of the target electrode plate.

In an embodiment, each of the plurality of transfer guides may include: a rotation shaft in a corresponding through-hole from among the plurality of through-holes, and protruding downwards from a lower surface of the stage, the rotation shaft including a flow line through which the injection gas may be supplied and flows; an injection body connected to the rotation shaft, and rotatably located in the corresponding through-hole, the injection body including an injection line that may be in communication with the flow line and inclined with respect to the upper surface of the stage to inject the injection gas outwards over the upper surface of the stage; and a rotation driver configured to rotate the rotation shaft to adjust the injection direction by changing a position of the injection line along a circumferential direction of the injection body.

In an embodiment, each of the plurality of the through-holes may include: a first hole recessed from the upper surface of the stage by a depth, and defining a step portion that may be stepped with respect to the upper surface of the stage and configured to support the injection body thereon; and a second hole penetrating through the stage at a central portion of the first hole to accommodate the rotation shaft.

In an embodiment, the apparatus may further include a rotation support member on the step portion to rotatably support the injection body.

In an embodiment, the injection line may have a volume smaller than that of the flow line to increase a flow rate of the injection gas injected from the injection line.

In an embodiment, the controller may include: an injection direction adjustment control configured to transmit information about the transfer direction to the rotation driver; and an injection rate adjustment control configured to adjust a flow rate of the injection gas.

In an embodiment, the apparatus may further include an injection source selectively connected to the flow line of each of the plurality of transfer guides to supply the injection gas.

In an embodiment, the injection source may include: a single compressor configured to compress the injection gas to a high pressure; and a plurality of branch supply lines through which the injection gas may be supplied from the single compressor to the flow lines of the plurality of transfer guides, respectively.

In an embodiment, the injection source may include a plurality of compressors connected to the flow lines of the plurality of transfer guides, respectively, to compress the injection gas to a high pressure.

In an embodiment, the injection gas may include compressed air, and the injection source may include an air compressor.

In an embodiment, the stage may include: an inlet configured to receive the target electrode plate inwards; and an outlet configured to discharge the target electrode plate outwards after being transferred in the transfer direction by the plurality of transfer guides. The plurality of transfer guides may be uniformly located in the stage.

In an embodiment, the outlet may be connected to at least one of a normal tray into which normal electrode plates may be gathered, or a defect tray into which defective electrode plates may be gathered and discarded.

In an embodiment, the apparatus may further include a fence surrounding a peripheral portion of the stage to face the outlet and the inlet, the fence being configured to prevent the electrode plate provided through the inlet from being separated from the stage in an area other than the outlet.

According to one or more embodiments of the present disclosure, a method of guiding an electrode plate, includes: connecting an inlet of a stage with a terminal pathway of a cutting apparatus, the stage including a plurality of transfer guides for transferring the electrode plate by spraying an injection gas; determining a transfer direction of the electrode plate from the inlet toward an outlet by detecting a position of the outlet; controlling the plurality of transfer guides to align an injection direction of the injection gas with the transfer direction; and transferring the electrode plate provided into the stage to the outlet by spraying the injection gas along the injection direction.

In an embodiment, the controlling of the plurality of transfer guides may include aligning the injection direction with the transfer direction by moving an injection line included in each of the plurality of transfer guides to spray the injection gas along a circumferential direction of a corresponding transfer guide from among the plurality of transfer guides by rotating the corresponding transfer guide.

In an embodiment, the injection gas may be injected outwards over an upper surface of the stage to float and move the electrode plate along the transfer direction.

According to some embodiments of the present disclosure, the electrode plate guiding apparatus may be detachably connected to (e.g., coupled to or attached to) a terminal pathway of a conveying belt for conveying (e.g., transferring) the electrode plate, so that the transfer direction of the electrode plate transferred via the conveying belt may be more easily and simply changed.

According to some embodiments of the present disclosure, by providing an injection line through which an injection gas is sprayed, and rotating the transfer guide disposed in the through-hole of the stage, the injection line may be adjusted to be directed towards the transfer direction of the electrode plate, thereby aligning the injection direction of the injection gas with the transfer direction of the electrode plate. Accordingly, the electrode plate may float above the stage, and may be moved (e.g., transferred) along the injection direction of the injection gas.

According to some embodiments of the present disclosure, when the transfer direction of the electrode plate is changed, the transfer guide may be rotated inside the through-hole to adjust the position of the injection line, so that the changed transfer direction aligns with the injection direction of the injection gas. As such, the transfer direction of the electrode plate transferred by the conveying belt may be more simply changed.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a diagram illustrating an apparatus for guiding an electrode plate according to an embodiment of the present disclosure;

FIG. 2 is a perspective view illustrating a stage included in the electrode plate guiding apparatus shown in FIG. 1;

FIG. 3 is a cross-sectional view illustrating a transfer guide provided in the electrode plate guiding apparatus shown in FIG. 1;

FIG. 4 is a plan view illustrating the transfer guide shown in FIG. 3; and

FIG. 5 is a flow chart illustrating a method for guiding an electrode plate to change a transfer direction of the electrode plate using the electrode plate guiding apparatus shown in FIG. 1.

### DETAILED DESCRIPTIONS

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

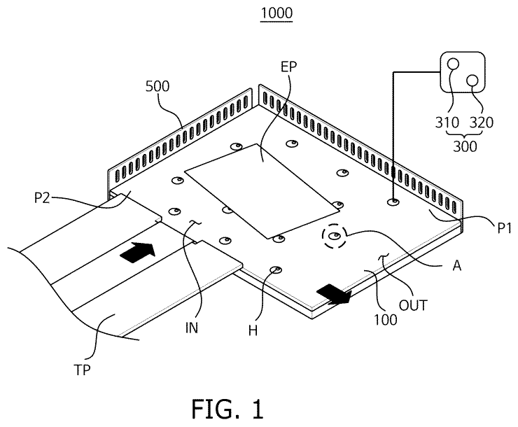

FIG. 1 is a diagram illustrating an apparatus for guiding an electrode plate according to an embodiment of the present disclosure.

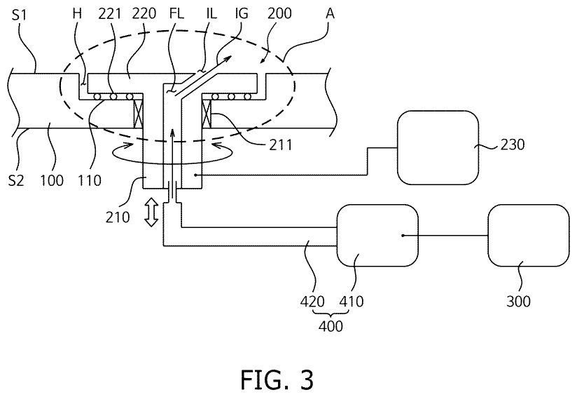

Referring to FIG. 1, an apparatus 1000 for guiding an electrode plate (hereinafter, also referred to as an electrode plate guiding apparatus 1000) according to an embodiment of the present disclosure may include a stage 100 and a plurality of transfer guides 200 (e.g., see FIG. 3). The stage 100 may have a plurality of through-holes H, and an inlet IN into which the electrode plate EP is provided. Each transfer guide 200 is located in a corresponding region A, and arranged in a corresponding through-hole H to change a transfer direction of the electrode plate EP to an outlet OUT of the stage 100 with (e.g., using) an injection gas IG.

The electrode plate guiding apparatus 1000 may further include a controller 300 that controls each of the transfer guides 200 to change an injection direction of the injection gas IG based on the transfer direction of the electrode plate EP, and a fence 500 that prevents the electrode plate EP provided onto the stage 100 from being deviated out of the stage 100.

For example, the electrode plate guiding apparatus 1000 may be connected to (e.g., coupled to or attached to) an end of a pathway TP (e.g., a terminal pathway) of a cutting apparatus, and may guide the electrode plate EP to change the transfer direction of the electrode plate EP to a direction different from the direction of the terminal pathway TP. The cutting apparatus may produce the electrode plate EP by cutting an electrode sheet including a mixture of an active material, conductive additives, and a binder, which is a slurry, that is coated on a surface of a substrate, such as a current collector, according to the desired specifications of the secondary battery.

For example, when a tray that accommodates the electrode plate EP and is fed to an electrode assembly process from the cutting apparatus is not aligned in a straight line with the terminal pathway TP, it may be difficult to change the transfer direction of the electrode plate EP in a comparative feeding line such as a conveyor belt. However, the electrode plate guiding apparatus 1000 according to an embodiment of the present disclosure may be more easily connected with (e.g., coupled with or attached with) the terminal pathway TP of the feeding line of the cutting apparatus, so that the direction of the electrode plate EP being transferred may be simply changed. In more detail, by changing the injection direction of the transfer guide 200 for guiding the transfer of the electrode plate EP, the transfer direction of the electrode plate EP being transferred may be simply changed.

In an embodiment, the stage 100 may have a flat plate shape with the plurality of through-holes H arranged therein. The stage 100 may be connected to the terminal pathway TP of the cutting apparatus, so that a target electrode plate EP slated for the change of its transfer direction may be provided to the stage 100. The transfer guides may be placed in the through-holes H. The plurality of through-holes H may be formed in various areas of the stage 100, such as the corners and the center of the stage 100. In FIG. 1, each through-hole H is shown as having a circular shape when viewed from above (e.g., in a plan view), but the present disclosure is not limited thereto. For example, the through-hole H may have various suitable shapes other than the circular shape. The through-hole H may penetrate the upper surface and the lower surface of the stage 100. The through-hole H may define (e.g., may have) a space to accommodate the transfer guide.

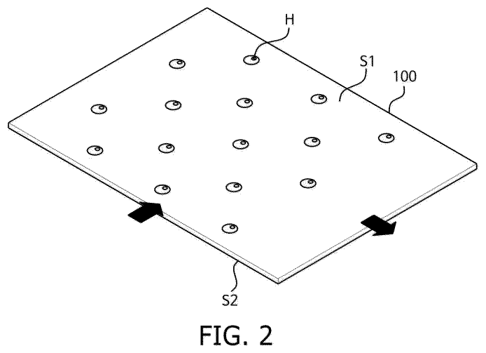

FIG. 2 is a perspective view illustrating the stage included in the electrode plate guiding apparatus shown in FIG. 1.

Referring to FIG. 2, the stage 100 may include (e.g., may be made of) various suitable materials that provide a sufficient strength and rigidity to ensure adequate stability when connected to (e.g., coupled to or attached to) the terminal pathway TP of the cutting apparatus, and to resist to the flow of the injection gas. Further, the stage 100 may have various suitable shapes as well as a flat plate shape, depending on the environment in which a change in the transfer direction of the electrode plate EP is desired.

In the present embodiment, the stage 100 may be connected to the terminal pathway TP located at an end of a belt conveyor, which serves as the feeding line of the cutting apparatus. The stage 100 may be provided as a rectangular flat plate having an inlet IN (e.g., see FIG. 1) through which the cut electrode plates EP are provided, and an outlet OUT through which the electrode plate EP having the changed transfer direction has been discharged.

The electrode plate EP having the transfer direction that is to be changed may be provided into the stage 100 through the inlet IN, and may be transferred to an upper surface S1 of the stage 100. Subsequently, the electrode plate EP may be redirected by the transfer guides 200, which will be described in more detail below, and then discharged from the stage 100 through the outlet OUT.

The plurality of through-holes H may be uniformly or substantially uniformly disposed on the surface of the stage 100, and an injection gas IG (e.g., see FIG. 3) may be injected through the through-holes H from the bottom. The injection gas IG may be injected from the transfer guides 200 inserted in the through-holes H, thereby floating (e.g., lifting) the electrode plate EP transferred to the upper surface S1 of the stage 100.

The injection gas IG may be controlled by the controller 300 to be injected along a direction of the transfer of the electrode plate EP, and the electrode plate EP may be guided by the injection gas IG in a floating state towards the outlet OUT. At the end of the outlet OUT, a normal tray for collecting electrode plates EP that are determined as normal, and a defect tray for collecting electrode plates EP that are determined as defective, may be arranged. Therefore, the normal electrode plates EP or the defective electrode plates EP may be more easily redirected to a direction different from the direction of the terminal pathway TP.

Compared to a robot arm that may have a large footprint, or an air blower that may have difficulty in a position control of the electrode plate, the electrode plate guiding apparatus 1000 according to some embodiments of the present disclosure may be removably connected to (e.g., coupled to or attached to) the terminal pathway TP with a smaller footprint. Thus, the transfer path of the electrode plate EP may be more simply changed to be different from the terminal pathway TP. In an embodiment, the transfer guide 200 is embedded in each of the plurality of through-holes H to inject (e.g., spray) the injection gas IG, and change the transfer direction or the transfer path of the target electrode plate, thereby discharging the target electrode plate EP from the stage 100.

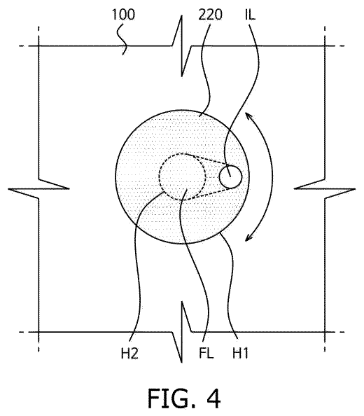

FIG. 3 is a cross-sectional view illustrating the transfer guide provided in the electrode plate guiding apparatus shown in FIG. 1. FIG. 4 is a plan view illustrating the transfer guide shown in FIG. 3. FIGS. 3 and 4 show enlarged views of the region A of the electrode plate guiding apparatus shown in FIG. 1.

Referring to FIGS. 3 and 4, the transfer guide 200 according to an embodiment of the present disclosure may include a rotation shaft 210, an injection body 220, and a rotation driver 230. For example, the rotation shaft 210 may be inserted into the through-hole H, and may protrude downwards from a lower surface S2 of the stage 100. A flow line FL through which the injection gas IG is supplied and flows may be disposed along a central portion of the rotation shaft 210.

The through-hole H may include a first hole H1 and a second hole H2. The first hole H1 may have a relatively larger diameter, and may be located at an upper portion of the stage 100. The second hole H2 may have a relatively smaller diameter, and may penetrate the stage 100 at a central portion of the first hole H1. Accordingly, a bottom surface of the first hole H1 may be provided as a step portion 110 that is stepped with respect to the upper surface S1 of the stage 100, and the second hole H2 may be bounded (e.g., may be surrounded around a periphery thereof) by the step portion 110. In other words, the first hole H1 may have the step portion 110 that is recessed from the upper surface S1 of the stage 100 by a suitable depth (e.g., a predetermined depth) to support the injection body 220, and the second hole H2 may penetrate through the stage 100 at the central portion of the step portion 110 to accommodate the rotation shaft 210.

The rotation shaft 210 may be inserted into the second hole H2, and may protrude downwards from the lower surface S2. A first rotation support member 211 may be arranged between an inner surface of the second hole H2 and the rotation shaft 210. For example, the transfer guide 200 may be rotatable by the first rotation support member 211 inside the second hole H2, when a rotational driving force is applied by the rotation driver 230 to the rotation shaft 210. In the present embodiment, the first rotation support member 211 may have a bearing structure capable of supporting a rotational movement along an axial direction.

The flow line FL may be disposed to pass through the rotation shaft 210, and may be connected to an injection source 400 that supplies the injection gas IG. For example, the injection source 400 may include a single compressor 410 that compresses the injection gas IG to a desired high pressure (e.g., a preset or predetermined high pressure), and branch supply lines 420 that supply the high-pressure injection gas IG from the compressor 410 to the flow lines FL, respectively. As another example, the injection source 400 may include a plurality of compressors connected to the flow lines FL, respectively, to thereby compress the injection gas IG to the high pressure.

The injection gas IG may be injected at an injection pressure sufficient to float (e.g., lift) the electrode plate EP entering onto the upper surface S1. Accordingly, the injection gas IG may be supplied at a pressure that is sufficiently high to float the electrode plate EP. For example, the compressor 410 may be an air compressor to utilize compressed air as the injection gas IG.

The branch supply lines 420 may be configured to concurrently or substantially simultaneously supply therethrough the injection gas IG from the compressor (e.g., the single compressor) 410 to the flow lines FL. Accordingly, the plurality of transfer guides 200 that are disposed in the plurality of through-holes H, respectively, may concurrently or substantially simultaneously inject the injection gas IG to float (e.g., to lift) the electrode plate EP above the upper surface S1. In a case where the through-holes H are uniformly or substantially uniformly arranged, the electrode plate EP may be lifted by the injection gas IG having a uniform or substantially uniform density.

Each branch supply line 420 may be connected to (e.g., coupled to or attached to) the corresponding flow line FL when (e.g., only when) the rotation shaft 210 stops rotating. The connection (e.g., the coupling) between the flow line FL and the branch supply line 420 may be disengaged during the rotation of the rotation shaft 210. Thus, an interference between the rotation shaft 210 and the branch supply line 420 due to a rotation of the rotation shaft 210 may be prevented.

In another embodiment, the branch supply line 420 may maintain or substantially maintain the connection (e.g., the coupling) with the flow line FL, even while the rotation shaft 210 is rotating. In this case, the injection gas IG may be injected even during the rotation of the rotation shaft 210 to facilitate the changing of the transfer direction of the electrode plate EP.

An injection line IL may have a volume smaller than that of the flow line FL, to increase a flow rate of the injection gas IG being injected from the injection line IL. For example, the injection line IL may have a diameter smaller than that of the flow line FL, to increase the flow rate of the injection gas IG being injected from the injection line IL.

The injection body 220 may be provided in the shape of a circular disk that is inserted into the first hole H1, and may be disposed to be supported on the step portion 110. The injection body 220 may be connected with (e.g., coupled with or attached with) the rotation shaft 210, so that they may be rotated together by the rotation of the rotation shaft 210. Accordingly, the transfer guide 200 may be provided in a T-shape with the injection body 220 having a relatively larger area, and the rotation shaft 210 may be disposed below the injection body 220 and may have a relatively smaller area.

In more detail, an outer circumferential surface of the injection body 220 may be disposed in the first hole H1 to be spaced apart from an inner surface of the first hole H1. A second rotation support member 221 may be provided between the step portion 110 and a lower surface of the injection body 220. Accordingly, the lower surface of the injection body 220 may be rotatably supported on an upper surface of the step portion 110, and the outer circumferential surface of the injection body 220 may be spaced apart from the inner surface of the first hole H1, so that the injection body 220 may rotate without interference.

The second rotation support member 221 may be disposed along a surface of the step portion 110 to rotatably support the injection body 220. For example, the second rotation support member 221 may include a roller structure having rollers that are circumferentially arranged on the upper surface of the step portion 110 having a hollow disk shape. However, the present disclosure is not limited thereto, and the second rotation support member 221 may have various suitable rotational support structures, as long as the injection body 220 is rotatable on the step portion 110.

Inside the injection body 220, at least one injection line IL communicated with the flow line FL may be disposed to be inclined with respect to the upper surface S1, so that the injection gas supplied through the flow line FL is injected (e.g., sprayed) at an angle above the upper surface S1 of the stage 100.

For example, the injection line IL may penetrate the injection body 220 at an inclination angle upward from the flow line FL to be exposed to the upper surface S1 of the stage 100. Accordingly, the injection gas IG injected through the injection line IL may have an injection direction that is upwardly directed from the upper surface S1 of the stage 100 by the inclination angle. Thus, the injection gas IG supplied from the injection source 400 may be injected upwards at the inclination angle through the flow line FL and the injection line IL to the upper surface of the stage 100, allowing the electrode plate EP that is provided onto the upper surface S1 of the stage 100 to float (e.g., to be lifted) from the upper surface S1 of the stage 100 by the injection gas IG.

In addition, an external force may be applied to the floating electrode plate EP by the injection gas IG injected along the injection direction, so that the electrode plate EP is transferred in a floating state along the injection direction. Therefore, the transfer direction of the electrode plate EP may be changed by changing the position of the injection line IL that inject (e.g., sprays) the injection gas IG.

The rotation driver 230 may be connected to the rotation shaft 210 protruding beyond the lower surface S2 to rotate the rotation shaft 210. For example, the rotation driver 230 may be configured as a step motor connected to the rotation shaft 210 to rotate the rotation shaft 210 by a desired angle (e.g., a set or predetermined angle).

When the rotation shaft 210 rotates inside the second hole H2, the injection body 220 also moves circumferentially inside the first hole H1. Thus, the injection line IL also rotates by the angular movement amount of the rotation shaft 210, thereby causing a change in the position of the injection line IL.

The electrode plate EP may be transferred along the injection direction of the injection gas IG injected through the injection line IL. Therefore, the position of the injection line IL may be adjusted by the rotation driver 230, such that the injection direction of the injection gas IG aligns with the transfer direction of the electrode plate EP. Consequently, the transfer direction of the electrode plate EP may also be changed.

In the present embodiment, by arranging the injection line IL to be directed towards the outlet OUT, the transfer direction may be changed to allow the electrode plate EP provided through the inlet IN to be discharged through the outlet OUT. Accordingly, the electrode plate EP may be supplied to the tray for the normal electrode plate and/or the tray for the defective electrode plate that are connected to the outlet OUT. If the position of the outlet OUT is changed due to a change in the positions of the tray for the normal electrode plate and/or the tray for the defective electrode plate, the position of the injection line IL may be adjusted by rotating the injection body 220 by the rotation driver 230 to direct the injection gas IG towards the outlet OUT having the changed position.

In an embodiment, the controller 300 may control the injection direction of the injection gas IG according to the transfer direction of the electrode plate EP by controlling the plurality of transfer guides 200. For example, the controller 300 may include an injection direction adjustment unit (e.g., an injection direction adjustment control or controller) 310 that transmits information about the transfer direction to the rotation driver 230, and an injection rate adjustment unit (e.g., an injection rate adjustment control or controller) 320 that configures (e.g., that sets or adjusts) the flow rate of the injection gas IG.

In an embodiment, the controller 300 may selectively control some (e.g., only some) of the plurality of transfer guides 200 to inject the injection gas IG, while controlling others of the plurality of transfer guides 200 not to inject the injection gas IG. In another embodiment, the controller 300 may selectively control some of the plurality of transfer guides 200 to inject the injection gas IG in a first direction, and control others of the plurality of transfer guides 200 to inject the injection gas IG in a second direction different from the first direction.

The injection direction adjustment unit 310 may detect the positions of the inlet IN and the outlet OUT of the stage 100, and configure (e.g., set or adjust) a trajectory related to the transfer direction of the electrode plate (EP) provided into the stage 100.

The inlet IN of the stage 100 may be connected to the terminal pathway (TP) of the cutting apparatus. Therefore, the direction facing the terminal pathway (TP) may be determined (e.g., may be set) as the reference direction, and a side portion of the stage 100 where the tray for the normal electrode plate and/or the tray for the defective electrode plate are located may be determined (e.g., may be set) as the outlet OUT. The trajectory of the transfer path of the electrode plate EP from the inlet IN to the outlet OUT may be extracted, and the position of the injection line IL may be adjusted (e.g., be set) to allow the electrode plate EP to be discharged to the outlet OUT.

Accordingly, the injection direction adjustment unit 310 may generate a rotation control signal to rotate the injection body 220, such that the injection line IL injecting the injection gas IG is directed towards the outlet OUT. Accordingly, the rotation driver 230 may rotate the rotation shaft 210 and the injection body 220 in response to the rotation control signal, to adjust the position of the injection line IL.

The injection rate adjustment unit 320 may adjust the flow rate of the injection gas IG injected through the injection line IL, thereby adjusting the floating gap between the stage 100 and the electrode plate EP. When the flow rate of the injection gas IG is too high, the floating gap between the electrode plate EP and the stage 100 may be increased, which may reduce a dynamic stability of the movement while moving above the upper surface of the stage 100, thereby reducing the precision of the positioning control with respect to the electrode plate EP. Therefore, the injection rate adjustment unit 320 may generate a flow control signal for a supply flow rate of the injection gas IG to control the injection source 400, and the injection source 400 may supply the injection gas IG to the flow line FL at the supply flow rate controlled based on the flow control signal. Accordingly, the injection gas IG is injected at a flow rate that allows the electrode plate EP to have a suitable floating gap from the stage 100.

The fence 500 (e.g., see FIG. 1) may be additionally disposed at the peripheral portion of the stage 100 to face the outlet OUT and the inlet IN, so that the electrode plate EP provided onto the stage 100 through the inlet IN is prevented from being separated from the stage 100 in an area other than the outlet OUT.

In the present embodiment, the fence 500 may include a first fence disposed along a first peripheral portion P1 of the stage 100 that is opposite to the inlet IN, and a second fence disposed along a second peripheral portion P2 of the stage 100 that is opposite to the outlet OUT.

The first fence may prevent the electrode plate EP provided into the inlet IN from leaving the stage 100 along the direction in which the electrode plate EP is provided. The second fence may prevent the electrode plate EP provided into the inlet IN from leaving the stage 100 along a direction opposite to the outlet OUT.

The fence 500 may be provided as an elongated member having a height that is greater than that of the upper surface of the stage 100, and extending along the longitudinal direction of the first and second peripheral portions P1 and P2. Further, the fence 500 may be removably connected to (e.g., removably coupled to or attached to) the stage 100, so that the fence 500 may be arranged at variable locations depending on the position of the inlet IN and the outlet OUT.

According to some embodiments described above, the electrode plate guiding apparatus 1000 may be removably connected to (e.g., removably coupled to or attached to) the terminal pathway TP of the conveying belt for transferring the electrode plate EP, so that the transfer direction of the electrode plate EP transferred via the conveying belt may be more easily and simply changed.

By providing the injection line IL through which the injection gas IG is sprayed, and rotating the transfer guide 200 disposed in the through-hole H of the stage, the injection line IL may be adjusted to be directed towards the transfer direction of the electrode plate EP, thereby aligning the injection direction of the injection gas IG with the transfer direction of the electrode plate EP. Accordingly, the electrode plate EP may float (e.g., may be lifted) and moved (e.g., transferred) along the injection direction of the injection gas IG.

When the transfer direction of the electrode plate EP is changed, the transfer guide 200 may be rotated inside the through-hole H to adjust the position of the injection line IL, so that the changed transfer direction aligns with (e.g., matches) the injection direction of the injection gas IG.

Accordingly, a change in the transfer direction of the electrode plate EP transferred by the conveying belt may be made more simply.

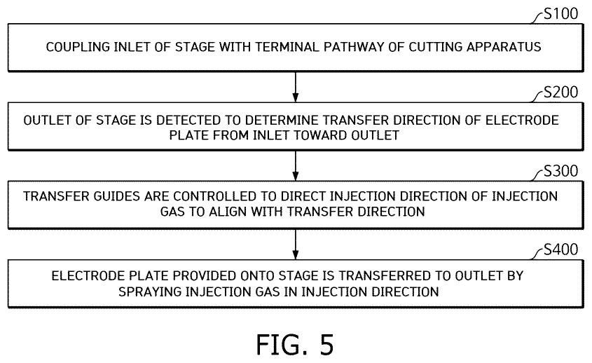

FIG. 5 is a flow chart illustrating a method for guiding the electrode plate EP to change the transfer direction of the electrode plate EP using the electrode plate guiding apparatus shown in FIG. 1.

The method for guiding the electrode plate shown in FIG. 5 may be performed using the electrode plate guiding apparatus 1000 described above with reference to FIGS. 1 to 4. Accordingly, hereinafter with reference to FIG. 5, like reference numerals are used to denote like (e.g., the same or substantially the same) parts as those described above with reference FIGS. 1 to 4, and thus, redundant description thereof may not be repeated.

Referring to FIG. 5, the terminal pathway TP of the cutting apparatus for cutting an electrode sheet into an electrode plate EP may be connected to (e.g., coupled to or attached to) the inlet IN of the stage 100 (S100).

The electrode plate EP may be formed by cutting the electrode sheet using a cutting apparatus, and the formed electrode plate EP may be transferred to an electrode assembly process, or may be transferred by the feeding line such as the conveying belt to extract a defective electrode plate EP. In this process, the inlet IN of the stage 100 may be connected to (e.g., coupled to or attached to) the terminal pathway TP of the conveying belt to introduce the electrode plate EP to the stage 100. The provided electrode plate EP may then be transferred to the outlet OUT of the stage 100 by changing the transfer direction thereof using the transfer guide 200 provided in the stage 100.

The outlet OUT of the stage 100 may be detected to determine the transfer direction of the electrode plate EP from the inlet IN toward the outlet OUT (S200).

For example, the injection direction adjustment unit 310 may detect the side of the stage 100 where the tray for collecting the normal electrode plates EP or the tray for collecting the defective pole plates EP is located as the outlet OUT, and may detect the transfer direction of the electrode plate EP that allows the electrode plate EP provided through the inlet IN to be discharged from the outlet OUT.

The injection direction adjustment unit 310 may obtain a position of the injection line IL for changing the direction of the electrode plate EP being transferred in the inlet IN to the direction towards the detected outlet OUT.

Next, the transfer guide may be controlled to align the injection direction of the injection gas IG with the transfer direction of the electrode plate EP (S300). For example, the transfer guide 200 may be rotatably installed in the through-hole H formed through the stage 100. The transfer guide 200 may include the rotation shaft 210 that is inserted into and rotatably fixed inside the second hole H2 located at a lower portion of the stage 100, and may protrude beyond the lower surface S2. The injection body 220 of the transfer guide 200 may be inserted into the first hole H1 located at an upper portion of the stage 100, and may be connected to (e.g., coupled to or attached to) the rotation shaft 210. The rotation driver 230 may rotate the rotation shaft 210.

The injection gas IG may be supplied along the flow line FL disposed inside the rotation shaft 210. The injection line IL may be formed through the injection body 220, and may be connected with the flow line FL in a structure in which the injection line IL is inclined at a suitable inclination angle (e.g., a certain or predetermined inclination angle) with respect to the upper surface S1 of the stage 100. Thus, the injection gas IG supplied through the flow line FL may be injected through the injection line IL. At this time, the injection gas IG is injected at the inclination angle to the upper surface S1 of the stage 100, allowing the electrode plate EP provided onto the upper surface S1 of the stage 100 to float (e.g., to be lifted) from the stage 100.

The injection body 220 may be connected to (e.g., coupled to or attached to) the rotation shaft 210, and rotatably disposed inside the first hole H1. Therefore, the injection body 220 may be rotated to align the injection line IL provided in the injection body 220 along the transfer direction of the electrode plate EP. Accordingly, the injection direction of the injection gas IG may be aligned with the transfer direction of the electrode plate EP by moving the injection line IL along the circumferential direction of the injection body 220.

Subsequently, the electrode plate EP provided into the stage 100 may be transferred to the outlet OUT by injecting (e.g., by spraying) the injection gas IG from the aligned injection line IL in the injection direction (S400).

The injection gas IG may be injected through the injection line IL aligned along the transfer direction of the electrode plate EP, and the injection gas IG may be injected at an inclination angle to the lower surface of the electrode plate EP provided to the stage 100.

Accordingly, the electrode plate EP may be lifted from the stage 100 by the injection gas IG, and transferred along the injection direction. Because the injection direction of the injection gas IG is determined (e.g., is preset or predetermined) by the rotation of the injection body 220 to align with the transfer direction of the electrode plate EP, the electrode plate EP is transferred to the outlet OUT along the transfer direction.

Thus, in a case where the position of the outlet OUT is changed, the injection body 220 may be rotated again to reset the injection line IL to be directed towards the position-changed outlet OUT. Accordingly, the transfer direction of the electrode plate EP may be changed more simply by connecting the electrode plate guiding apparatus to the end of a conveying belt or the end of a conveyor.

According to the electrode plate guiding apparatus and the electrode plate guiding method for changing the transfer direction as described above, the electrode plate guiding apparatus may be detachably connected to (e.g., detachably coupled to or attached to) the terminal pathway TP of the conveying belt for conveying (e.g., for transferring) the electrode plate EP, so that the transfer direction of the electrode plate transferred via the conveying belt may be easily and simply changed.

By providing the injection line IL through which the injection gas IG is sprayed, and rotating the transfer guide 200 disposed in the through-hole H of the stage, the injection line IL may be adjusted to be directed towards the transfer direction of the electrode plate EP, thereby aligning the injection direction of the injection gas IG with the transfer direction of the pole plate EP. Accordingly, the electrode plate EP may float and be moved (e.g., transferred) along the injection direction of the injection gas IG.

When the transfer direction of the electrode plate EP is changed, the transfer guide 200 may be rotated inside the through-hole H to adjust the position of the injection line IL, so that the changed transfer direction aligns with (e.g., matches) the injection direction of the injection gas IG.

Accordingly, the transfer direction of the electrode plate EP transferred by the conveying belt may be simply changed as needed or desired.

The transferred electrode plates EP may be utilized in assembling the electrode assembly. The electrode assembly may include a first electrode plate, a second electrode plate, a separator, and the like. The transferred electrode may be used as either the first electrode plate or the second electrode plate. The first electrode plate, the second electrode plate, and the separator may each be formed as a thin plate or a film. The electrode assembly may include a suitable structure in which the first electrode plate, the separator, and the second electrode plate are sequentially stacked and wound, or repeatedly stacked.

When the electrode assembly is a wound stack, a winding axis may be parallel to the longitudinal direction of the case. In other embodiments, the electrode assembly may be a stack type rather than the winding type, and the shape of the electrode assembly is not limited in the present disclosure. In addition, the electrode assembly may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. Of course, the reverse is also possible.

The first electrode plate may be formed by applying a first electrode active material, such as graphite or carbon, to a first electrode current collector formed of a metal foil, such as copper, a copper alloy, nickel, or a nickel alloy. The first electrode plate may include a first electrode tab (e.g., a first uncoated portion) that is a region to which the first electrode active material is not applied. The first electrode tab may act as a current flow path between the first electrode plate and the first current collector. In some embodiments, when the first electrode plate is manufactured, the first electrode tab may be formed by being cut in advance to protrude to one side of the electrode assembly, or the first electrode tab may protrude to one side of the electrode assembly more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab (e.g., a second uncoated portion) that is a region to which the second electrode active material is not applied. The second electrode tab may act as a current flow path between the second electrode plate and the second current collector. In some embodiments, the second electrode tab may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In some embodiments, the first electrode tab may be located on the left side of the electrode assembly, and the second electrode tab may be located on the right side of the electrode assembly. In other embodiments, the first electrode tab and the second electrode tab may be located on one side of the electrode assembly in the same direction. Here, for convenience of description, the left and right sides are defined according to the secondary battery, and the positions thereof may change when the secondary battery is rotated left and right or up and down.

The first electrode tab of the first electrode plate and the second electrode tab of the second electrode plate may be respectively positioned at both ends (e.g., opposite ends) of the electrode assembly. In some embodiments, the electrode assembly may be accommodated in the case along with an electrolyte. In addition, in the electrode assembly, the first current collector and the second current collector may be welded and connected to the first electrode tab of the first electrode plate and the second electrode tab of the second electrode plate exposed on both sides, respectively, to then be positioned thereat, respectively.

The separator may be positioned between the first electrode plate and the second electrode plate. The separator may prevent the electrical short between the first electrode plate and the second electrode plate. For example, the separator may be made of, for example, polyethylene, polypropylene, a porous copolymer of polyethylene and polypropylene. However, the composition of the separator according to the present enclosure is not limited thereto.

The electronic or electric devices and/or any other relevant devices or components according to embodiments of the present disclosure described herein (e.g., the controller, the injection direction adjustment unit, the injection rate adjustment unit, and the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. An apparatus for guiding an electrode plate, the apparatus comprising:
a flat plate-shaped stage having a plurality of through-holes, and comprising an upper surface configured to receive a target electrode plate thereon;
a plurality of transfer guides in the plurality of through-holes, and configured to inject an injection gas to change a transfer direction of the target electrode plate and discharge the target electrode plate from the stage; and
a controller configured to control the plurality of transfer guides to change an injection direction of the injection gas according to the transfer direction of the target electrode plate.

2. The apparatus as claimed in claim 1, wherein each of the plurality of transfer guides comprises:
a rotation shaft in a corresponding through-hole from among the plurality of through-holes, and protruding downwards from a lower surface of the stage, the rotation shaft comprising a flow line through which the injection gas is supplied and flows;
an injection body coupled to the rotation shaft, and rotatably located in the corresponding through-hole, the injection body comprising an injection line that is in communication with the flow line and inclined with respect to the upper surface of the stage to inject the injection gas outwards over the upper surface of the stage; and
a rotation driver configured to rotate the rotation shaft to adjust the injection direction by changing a position of the injection line along a circumferential direction of the injection body.

3. The apparatus as claimed in claim 2, wherein each of the plurality of the through-holes comprises:
a first hole recessed from the upper surface of the stage by a depth, and defining a step portion that is stepped with respect to the upper surface of the stage and configured to support the injection body thereon; and
a second hole penetrating through the stage at a central portion of the first hole to accommodate the rotation shaft.

4. The apparatus as claimed in claim 3, further comprising a rotation support member on the step portion to rotatably support the injection body.

5. The apparatus as claimed in claim 2, wherein the injection line has a volume smaller than that of the flow line to increase a flow rate of the injection gas injected from the injection line.

6. The apparatus as claimed in claim 2, wherein the controller comprises:
an injection direction adjustment control configured to transmit information about the transfer direction to the rotation driver; and
an injection rate adjustment control configured to adjust a flow rate of the injection gas.

7. The apparatus as claimed in claim 2, further comprising an injection source selectively connected to the flow line of each of the plurality of transfer guides to supply the injection gas.

8. The apparatus as claimed in claim 7, wherein the injection source comprises:
a single compressor configured to compress the injection gas to a high pressure; and
a plurality of branch supply lines through which the injection gas is supplied from the single compressor to the flow lines of the plurality of transfer guides, respectively.

9. The apparatus as claimed in claim 7, wherein the injection source comprises a plurality of compressors connected to the flow lines of the plurality of transfer guides, respectively, to compress the injection gas to a high pressure.

10. The apparatus as claimed in claim 7, wherein the injection gas comprises compressed air, and the injection source comprises an air compressor.

11. The apparatus as claimed in claim 1, wherein the stage comprises:
an inlet configured to receive the target electrode plate inwards; and
an outlet configured to discharge the target electrode plate outwards after being transferred in the transfer direction by the plurality of transfer guides, and
wherein the plurality of transfer guides are uniformly located in the stage.

12. The apparatus as claimed in claim 11, wherein the outlet is connected to at least one of a normal tray into which normal electrode plates are gathered, or a defect tray into which defective electrode plates are gathered and discarded.

13. The apparatus as claimed in claim 12, further comprising a fence surrounding a peripheral portion of the stage to face the outlet and the inlet, the fence being configured to prevent the electrode plate provided through the inlet from being separated from the stage in an area other than the outlet.

14. A method of guiding an electrode plate, the method comprising:
coupling an inlet of a stage with a terminal pathway of a cutting apparatus, the stage comprising a plurality of transfer guides for transferring the electrode plate by spraying an injection gas;
determining a transfer direction of the electrode plate from the inlet toward an outlet by detecting a position of the outlet;
controlling the plurality of transfer guides to align an injection direction of the injection gas with the transfer direction; and
transferring the electrode plate provided into the stage to the outlet by spraying the injection gas along the injection direction.

15. The method as claimed in claim 14, wherein the controlling of the plurality of transfer guides comprises:
aligning the injection direction with the transfer direction by moving an injection line included in each of the plurality of transfer guides to spray the injection gas along a circumferential direction of a corresponding transfer guide from among the plurality of transfer guides by rotating the corresponding transfer guide.

16. The method as claimed in claim 14, wherein the injection gas is injected outwards over an upper surface of the stage to float and move the electrode plate along the transfer direction.
